(19) United States
(12) Patent Application Publication
(10) Pub. No.: US 2025/0154414 A1
(43) Pub. Date: May 15, 2025

(54) DEMULSIFYING METHOD

(71) Applicant: Bachman Services LLC, Oklahoma City, OK (US)

(72) Inventors: Gregg Compton HAIGHT, Edmond, OK (US); Cameron Michael ENTWISTLE, Spring, TX (US)

(21) Appl. No.: 18/947,621

(22) Filed: Nov. 14, 2024

Related U.S. Application Data
(60) Provisional application No. 63/658,106, filed on Jun. 10, 2024.
(60) Provisional application No. 63/599,347, filed on Nov. 15, 2023.

(51) Int. Cl. C10G 33/04

(52) U.S. Cl. CPC C10G 33/04

(57) ABSTRACT

A method of demulsifying a hydrocarbon emulsion, the method comprising adding one or more biosurfactants to the hydrocarbon emulsion.

### FIELD

The invention relates to a method of demulsifying a hydrocarbon emulsion using one or more biosurfactants, and to the use of one or more biosurfactants to demulsify a hydrocarbon emulsion. The invention also relates to an additive composition comprising one or more biosurfactants.

### BACKGROUND

An emulsion is a combination of two immiscible liquids wherein one of the liquids is dispersed throughout the other liquid such as in small droplets. Numerous hydrocarbon emulsions are known, which may be naturally occurring or may result from domestic and industrial processes, for example by the formation of desired emulsions or of waste products. For example, hydrocarbon emulsions may result from the processing of waste oils such as lubricants (especially blends of lubricants from different sources) and diesel, which form an emulsion with an aqueous component.

Hydrocarbons such as crude oil (produced from geological formations) typically contain inorganic salts, such as calcium, sodium and magnesium chlorides. These salts may cause precipitate and emulsion formation, which can lead to operational problems such as the obstruction of flow through pipes, corrosion, increased heat capacity, fouling of equipment, and/or poisoning of catalysts. Such salts are therefore removed before processing of the hydrocarbons.

Inorganic salts are typically removed from the hydrocarbons by washing with an aqueous component such as water. However, such water washing produces undesirable water-hydrocarbon emulsions and if not removed, the water may cause corrosion to equipment, such as processing and fractionation equipment. Water may also be introduced into hydrocarbons during processing and/or storage, again leading to the formation of undesirable emulsions.

Waste hydrocarbon emulsions are typically disposed of in landfill in a similar manner to hydrocarbons as it can be difficult to separate the hydrocarbon from the aqueous component. However, if it is possible to separate or demulsify the hydrocarbon emulsion, the hydrocarbon component can be repurposed, for example into asphalt or roofing material (non-carbon emitting reuse) thus reducing the amount of waste in landfill.

It is known to treat waste oil emulsions with demulsifying additives such as oil soluble surfactant blends containing resins, esters, polyglycols, resin esters, amine oxyalkylates, sulfonates, sulfonate salts, diepoxides and polymerised polyols. Whilst these demulsifying additives do act to demulsify hydrocarbon emulsions, they typically do not function efficiently and/or provide clean separation of the aqueous component from the hydrocarbon component. If efficient and clean separation is not obtained, then the resulting hydrocarbon component will not be suitable for repurposing and further use, such that it will still need to be disposed of in landfill. Poor separation will therefore result in the loss of significant quantities of hydrocarbon, and may also result in the introduction of undesirable quantities of dirt into the hydrocarbon from the aqueous component.

Thus, there remains a need for alternative and/or improved methods for demulsifying hydrocarbon emulsions, for example which separate an aqueous component such as water quickly and efficiently and/or which provide clean separation of the aqueous component from the hydrocarbon. For example, it is desirable to minimise residual emulsion, avoiding traces of hydrocarbon in the aqueous component which are later discarded and lost.

It is thus an object of the present invention to provide methods of demulsifying a hydrocarbon emulsion, which methods may be more effective than, or which may provide an alternative to, existing methods of demulsifying hydrocarbon emulsions.

### SUMMARY

According to a first aspect of the invention, there is provided a method of demulsifying a hydrocarbon emulsion, the method comprising adding one or more biosurfactants to the hydrocarbon emulsion.

According to a second aspect of the invention, there is provided the use of one or more biosurfactants to demulsify a hydrocarbon emulsion.

According to a third aspect of the invention, there is provided an additive composition comprising one or more biosurfactants and one or more alkoxylated alcohol and/or amine compounds.

According to a fourth aspect of the invention, there is provided a method of demulsifying a hydrocarbon emulsion, the method comprising adding a water-based additive composition to the hydrocarbon emulsion, wherein the water-based additive composition comprises one or more biosurfactants.

According to a fifth aspect of the invention, there is provided the use of a water-based additive composition to demulsify a hydrocarbon emulsion, wherein the water-based additive composition comprises one or more biosurfactants.

According to a sixth aspect of the invention, there is provided an additive kit comprising a first additive composition comprising one or more biosurfactants and one or more alkoxylated alcohol and/or amine compounds and a second additive composition comprising one or more additional additives.

### DETAILED DESCRIPTION

Unless otherwise stated, the following terms used in the specification and claims have the meanings set out below.

The terms “alkyl” and “alkylene” include both straight and branched chain alkyl and alkylene groups respectively unless otherwise stated.

The term “hydrocarbyl” is used in its ordinary sense, which is well-known to those skilled in the art. Specifically, it refers to a group having a carbon atom directly attached to the remainder of the molecule and having predominantly hydrocarbon character.

The terms “demulsification”, “demulsifying”, “demulsify” and suchlike would be well understood by persons skilled in the art. For example, these terms would be well understood to mean the that an emulsion is substantially or completely broken down into its constituents (for example such that the emulsion is no longer formed). Specifically, these terms may refer to the use of one or more biosurfactants to mitigate naturally occurring emulsifying agents and/or to reduce interfacial tension to enable coalescence of droplets in a discontinuous phase of the emulsion.

Throughout this specification, when we refer to “demulsification”, “demulsifying”, “demulsify” and suchlike, we mean to refer to separating or improving the separation of an emulsion, for example so as to substantially or completely separate the components of the emulsion.

As used in the specification and the appended claims, the singular forms “a”, “an,” and “the” include both singular and plural referents unless the context clearly dictates otherwise.

Throughout this specification, the term “comprising” or “comprises” means including the component(s) specified but not to the exclusion of the presence of other components. The term “consisting essentially of” or “consists essentially of” means including the components specified but excluding other components except for components added for a purpose other than achieving the technical effect of the invention. The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

As used herein, unless otherwise expressly specified, all numbers such as those expressing values, ranges, amounts of percentages may be read as if prefaced by the word “about”, even if the term does not expressly appear.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.70 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The optional features set out herein may be used either individually or in combination with each other where appropriate and particularly in the combinations as set out in the accompanying claims. The optional features for each exemplary aspect of the invention, as set out herein are also applicable to any other aspects or exemplary aspects of the invention, where appropriate. In other words, the skilled person reading this specification should consider the optional features for each aspect or embodiment of the invention as interchangeable and combinable between different aspects of the invention.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

In this specification, unless otherwise stated, any reference to ppm is to parts per million by volume.

According to a first aspect of the invention there is provided a method of demulsifying a hydrocarbon emulsion, the method comprising adding one or more biosurfactants to the hydrocarbon emulsion.

According to a second aspect of the invention there is provided a use of one or more biosurfactants to demulsify a hydrocarbon emulsion.

The term “hydrocarbon emulsion” would be well understood by a person skilled in the art to mean an emulsion comprising a hydrocarbon component and an aqueous component. Typically, the hydrocarbon emulsion will comprise an aqueous component dispersed in a hydrocarbon component, such as droplets of the aqueous component dispersed throughout the hydrocarbon component wherein the aqueous component is not soluble in or miscible with the hydrocarbon component. For example, such a hydrocarbon emulsion may be known as a water in hydrocarbon, or a water in oil, emulsion. The hydrocarbon emulsion may alternatively comprise a hydrocarbon component dispersed in an aqueous component, such as droplets of the hydrocarbon component dispersed throughout the aqueous component wherein the hydrocarbon component is not soluble in or miscible with the aqueous component. For example, such a hydrocarbon emulsion may be known as a hydrocarbon in water, or an oil in water, emulsion. Further examples of a hydrocarbon emulsion include complex emulsions such as a water in hydrocarbon in water (for example a water in oil in water) or a hydrocarbon in water in hydrocarbon (for example an oil in water in oil) emulsion.

By “demulsifying a hydrocarbon emulsion” we mean to substantially or completely separate an aqueous component from a hydrocarbon component of the hydrocarbon emulsion. Thus, by separating the aqueous component, this provides the hydrocarbon in a form that is substantially free or is free of the aqueous component (i.e. such that demulsification occurs). The level of demulsification (or separation) may be measured using any suitable method, such as the method described in the examples provided herein. Preferably, the demulsification provides a clean interface between the aqueous and the hydrocarbon components of the emulsion.

By “substantially free of the aqueous component” we mean that any aqueous component (such as water) that is present, if any, is present as an incidental impurity. By “free of the aqueous component” we mean that no aqueous component (such as water) is present.

The method of the first aspect of the invention comprises adding one or more biosurfactants to the hydrocarbon emulsion. The use of the second aspect of the invention refers to the use of one or more biosurfactants to demulsify a hydrocarbon emulsion. Thus, the method and use of the invention make use of one or more biosurfactants.

References herein to one or more biosurfactants includes mixtures of different biosurfactants when more than one biosurfactant is used.

By the term “biosurfactant” we mean a surfactant that is produced by microorganisms, for example which may be a product of a fermentation process. Typically, a biosurfactant is generated as a metabolic product during bacterial, fungal or algal fermentation, and the metabolic product may be further derivatised. Thus, references herein to a biosurfactant refer to biosurfactants that are direct metabolic products of bacterial, fungal or algal fermentation, as well as derivatives of the direct metabolic products. Similarly, references herein to a specific biosurfactant also refer to derivatives of that biosurfactant unless otherwise stated.

The use of biosurfactants in the method and use of the invention is advantageous, because biosurfactants are natural products, are generated in a sustainable way, are environmentally benign and typically have low toxicity.

Biosurfactants are typically classified in four categories as polymeric biosurfactants, lipopeptides (or also called proteo-lipids), phospholipids and glycolipids. The one or more biosurfactants may be a complex mixture of biosurfactants.

Biosurfactants may comprise one or more fatty acid and/or fatty alcohol residues. Suitably biosurfactants useful in the invention comprise one or more fatty acid residues.

The one or more fatty acid and/or fatty alcohol residues that may be present in the biosurfactants may be the same or different and may be derived from any suitable fatty acid and/or fatty alcohol, preferably from a naturally occurring fatty acid and/or fatty alcohol. Fatty acid residues are mostly derived from natural plant oils in the form of triglycerides. For example, biocatalysts may hydrolyse lipid esters in natural plant oils forming fatty acids and glycerol. Suitably, the fatty acid and/or fatty alcohol residues may comprise a branched or unbranched, saturated or unsaturated, hydrocarbyl group.

The fatty acid and/or fatty alcohol residues that may be present in the biosurfactants may comprise from 4 to 50 carbon atoms, for example from 6 to 30 carbon atoms, preferably from 8 to 24 carbon atoms, more preferably from 12 to 22, or from 14 to 20 or from 16 to 18 carbon atoms. Preferred biosurfactants may therefore comprise residues of fatty acids derived from oleic acid, hydroxy substituted oleic acid (such as ricinoleic acid), palmitic acid and vegetable oils (such as sunflower, corn, soya, safflower oil and rapeseed oil).

Any suitable biosurfactant(s) may be used. For example, the one or more biosurfactants may be independently selected from a glycolipid, a lipopeptide, a phospholipid and a polymeric biosurfactant (and mixtures thereof).

The one or more biosurfactants may each have any suitable molecular weight, such as a molecular weight of from 200 to 3000 g mol⁻¹, for example from 250 to 2000 g mol⁻¹, such as from 500 to 1500 g mol⁻¹.

The one or more biosurfactants may be glycolipids. Glycolipids comprise one or more carbohydrate residues in addition to the one or more fatty acid and/or fatty alcohol residues. The carbohydrate and fatty acid/fatty alcohol residues are joined either by means of a linker group or a direct bond, for example via an ester, amide or glycosidic bond.

Suitable glycolipids may comprise one or more carbohydrate residues selected from rhamnose, trehalose, sophorose, mannose, galactose, glucose, cellobiose, glucosamine, sulfoquinovose, fructose, xylose, sucrose, lactose, maltose, sorbitol, erythritol and/or mannitol residues. For example, the one or more carbohydrate residues may be selected from rhamnose, trehalose, sophorose, mannose, erythritol, galactose, cellobiose and/or glucose residues. Preferably, the one or more carbohydrate residues may be selected from rhamnose, trehalose, sophorose, mannose and/or erythritol residues. More preferably, the one or more carbohydrate residues may be selected from sophorose and/or rhamnose residues. Most preferably, the one or more carbohydrate residues may be sophorose residues.

Suitable glycolipids may be selected from one or more of a rhamnolipid, a trehalolipid, a sophorolipid, a mannosylerythritol lipid, a glycolipid produced by Meyerozama guilliermondii, Saccharomyces cerevisiae, Candida utilis, Candida bombicola and/or Marinobacter hydrocarbonoclasticus.

For example, suitable glycolipids may be selected from one or more of a rhamnolipid, a trehalolipid, a sophorolipid and/or a mannosylerythritol lipid. Suitably, the one or more biosurfactants are sophorolipids.

For example, the one or more biosurfactants may be independently selected from a rhamnolipid, a trehalolipid, a sophorolipid and a mannosylerythritol lipid. The one or more biosurfactants may be selected from one or more rhamnolipids and/or one or more sophorolipids. Suitably, the one or more biosurfactants are sophorolipids.

Rhamnolipids comprise a rhamnose residue. Examples of suitable rhamnolipids may include those produced by species of Pseudomonas, Lysinibacillus and/or Serratia, for example those produced by Pseudomonas aeruginosa, Pseudomonas cepacia, Lysinibacillus sphaericus and/or Serratia rubidaea. Trehalolipids comprise a trehalose residue. Examples of suitable trehalolipids may include those produced by species of Nocardia, Rhodococcus, Starmerella, Arthrobacter, Corynebacterium and/or Candida, for example those produced by Rhodococcus erythropolis, Nocardia farcinica and/or Candida bombicola (also known as Starmerella bombicola).

Sophorolipids comprise a sophorose residue. Examples of suitable sophorolipids may include those produced by species of Candida, Starmerella and/or Cutaneotrichosporon, for example those produced by Candida sphaerica, Starmerella bombicola and/or Cutaneotrichosporon mucoides. Suitable sophorolipids may exist in the “lactonic” form wherein a fatty acid residue is bonded separately to each ring of the sophorose residue to form a lactonic macrocycle. When the fatty acid residue is not bonded to a sophorose residue this may be known as the “acidic” form. Suitable sophorolipids may have a molar ratio of acidic to lactonic form in the range 99:1 to 1:99, for example in the range 50:50 to 60:40. Suitable sophorolipids may have a molar ratio of acidic to lactonic form of 70:30. Suitably, greater than 60%, for example greater than 70%, preferably greater than 80%, more preferably greater than 90%, of the sophorolipids may comprise an unsaturated fatty acid and/or fatty alcohol residue.

Mannosylerythritol lipids comprise a mannose residue and an erythritol residue, preferably joined by an ether bond. Examples of suitable mannosylerythritol lipids may include those produced by species of Pseudozyma and/or Ustilago, for example Pseudozyma aphidis or Pseudozyma antarctica.

The one or more biosurfactants may be lipopeptides. Lipopeptides comprise one or more peptide residues in addition to the one or more fatty acid and/or fatty alcohol residues. The one or more peptide residues may be cyclic peptide residues. Suitable lipopeptides may include surfactins, lichenysins, and/or those produced by Pseudomonas azotoformans, Bacillus velezensis, Bacillus pseudomycoides, Virgibacillus salaries, Bacillus cereus, Bacillus pumilius or Halomonas species.

Surfactins may be produced by Bacillus species, such as B. subtillis or B. nealsonii.

Lichenysins may be produced by Bacillus species, such as B. licheniformis.

For example, the one or more biosurfactants may be independently selected from surfactin and lichenysin.

The one or more biosurfactants may be phospholipids. Phospholipids comprise one or more phosphate groups in addition to the one or more fatty acid and/or fatty alcohol residues. Phospholipids may further comprise a linker group joining the one or more phosphate groups and the one or more fatty acid and/or fatty alcohol residues. Suitable linker groups may for example comprises an alcohol residue such as glycerol or sphingosine. Suitable phospholipids include those produced by species of Acinetobacter and/or Acidithiobacillus, for example Acidithiobacillus thiooxidans.

The one or more biosurfactants may be polymeric biosurfactants. Polymeric biosurfactants are biopolymers (e.g. polysaccharides, polypeptides) comprising fatty acid and/or fatty alcohol residues.

Suitable polymeric biosurfactants include cellulose, guar, diutan, starch, chitin, chitosan, glycogen, xanthan, dextran, dextrin, welan, gellan, pullulan, pectin, scleroglucan, schizophyllan, levan, locust bean gum, peptidoglycan, tara, konjak, tamarind, starch, karaya, tragacanth, carrageenan, glycan, succinoglycan, glucan, scleroglucan, maltodextrin, cyclodextrin, inulin, alginates, amylose, amylopectin, liposan, rufisan, emulsan, lipomanan and/or alasan. Polymeric biosurfactants may include those produced by species of Candida and/or Acinetobacter, for example Candida lipolytica, Acinetobacter Iwoffi and/or Acinetobacter radioresistens.

For example, the one or more biosurfactants may be independently selected from liposan, rufisan, emulsan and alasan.

For example, the one or more biosurfactants may be independently selected from a rhamnolipid, a trehalolipid, a sophorolipid, a mannosylerythritol lipid, surfactin, lichenysin, liposan, rufisan, emulsan and alasan.

Biosurfactants useful in the invention may be those produced by species of Pseudomonas, Lysinibacillus, Serratia, Nocardia, Rhodococcus, Candida, Starmerella, Cutaneotrichosporon, Pseudozyma, Meyerozyma, Saccharomyces, Marinobacter, Bacillus, Lactobacillus Virgibacillus, Halomonas, Thiobacillus, Acidithiobacillus, Klebsiella, Alcanivorax, Arthrobacter, Rhodotorula, Tsukamurella, Ustilago, Sphingomonas, Mycobacterium, Streptomyces, Gluconobacter, Aspergillus and/or Acinetobacter.

The biosurfactants that are produced by a specific micro-organism may vary depending on the feedstock used and other variables in the growth conditions (e.g. temperature, pH, agitation and dissolved oxygen). Preferably, feedstocks comprise carbohydrates and/or lipids. Preferred lipid feedstocks are in the form of triglycerides. The feedstocks may comprise agricultural and/or industrial waste, for example vegetable oils, animal or vegetable fats, cooking oil waste, whey, glycerol, and/or combinations thereof. Biosurfactants suitable for the invention are preferably produced by micro-organisms from feedstock comprising carbohydrate and one or more lipids. More preferably, they are produced from feedstock comprising carbohydrate and one or more of vegetable oils (for example rapeseed, palm, sunflower, corn, soya and/or safflower oils), animal fats and vegetable fats.

Biosurfactants useful in the invention may be recovered from the fermentation broth before use by known recovery methods. For example, the biosurfactants may be recovered by precipitation, filtration (including ultrafiltration), adsorption to solid supports, centrifugation, chromatography (e.g. ion-exchange chromatography), foam fractionation, liquid-liquid extraction, and/or gravity separation (decanting).

Biosurfactants useful in the invention may be used as crude extracts, or they may undergo further purification and/or derivatisation before use.

Where biosurfactants are further purified, this may involve one or more purification techniques available to the skilled person, for example chromatographic techniques, ultrafiltration or washing with a suitable solvent (which solvent may be polar or non-polar).

Where biosurfactants are further derivatised, this may comprise derivatisation of the fatty acid and/or fatty alcohol residues. Where the fatty acid or fatty alcohol residue has an unsaturated alkyl group, suitable methods for derivatisation of the fatty acid or fatty alcohol residue include mild reductive, strong reductive or oxidative ozonolysis with sodium periodate (resulting in a dialdehyde, diol or diacid respectively); dihydroxylation, for example with OsO₄; epoxidation, for example with m-chloroperoxybenzoic acid; reduction, for example with H₂ on a Pd/C catalyst; ring opening metathesis; treatment with HBr; or mono-hydroxylation, for example by hydroboration with an oxidative work-up.

Where the biosurfactant is a glycolipid, the carbohydrate may be derivatised at the alcohol groups by esterification (e.g. with an anhydride), carboxymethylation (e.g. with an α-chloro acid), oxidation (to e.g. aldehyde or carboxylic acid), reaction with a non-ionic epoxide (e.g. ethylene oxide, propylene oxide), reaction with a cationic epoxide (e.g. glycidyltrimethyl ammonium chloride). The carbohydrate may be further derivatised by oxidative ring opening (e.g. with a periodate) resulting in a dialdehyde.

Derivatives of biosurfactants comprising aldehyde groups may be further derivatised, for example to alcohols, carboxylic acids, esters, amides, imines and/or amines. Derivatives of biosurfactants comprising carboxylic acid groups may be further derivatised, for example to esters and/or amides. Derivatives of biosurfactants comprising 1,2-diol groups may be further derivatised, for example by C—C bond cleavage with periodate or peroxide, or reaction with an aldehyde.

The one or more biosurfactants may be comprised in an additive composition, such as an additive composition according to the third aspect of the invention. In other words, the method or use of the invention may utilise an additive composition that comprises one or more biosurfactants.

The first aspect of the invention may provide a method of demulsifying a hydrocarbon emulsion, the method comprising adding an additive composition according to the third aspect of the invention to the hydrocarbon emulsion.

The second aspect of the invention may provide a use of an additive composition according to the third aspect of the invention to demulsify a hydrocarbon emulsion.

The additive composition may further comprise one or more alkoxylated alcohol and/or amine compounds, suitably one or more alkoxylated polyol and/or polyamine compounds. References herein to one or more alkoxylated alcohol and/or amine compounds refer to both the alcohol and the amine compounds being alkoxylated, i.e. to one or more alkoxylated alcohol and/or alkoxylated amine compounds. Similarly, references herein to one or more alkoxylated polyol and/or polyamine compounds refer to both the polyol and the polyamine compounds being alkoxylated, i.e. to one or more alkoxylated polyol and/or alkoxylated polyamine compounds.

By an “alkoxylated alcohol compound” we mean to include any compound including one or more hydroxy functional groups and which has been reacted with at least one alkylene oxide moiety, i.e. such that the compound comprises one or more hydroxy functional groups and at least one alkylene oxide residue. Such compounds will be known to persons skilled in the art and may comprise further functional groups. For example, an alkoxylated alcohol compound may comprise one or more amine functional groups in addition to the one or more hydroxy functional groups and at least one alkylene oxide residue. Thus, the alkoxylated alcohol compound may be an alkoxylated alkanolamine compound.

By an “alkoxylated amine compound” we mean to include any compound including one or more amine functional groups and which has been reacted with at least one alkylene oxide moiety, i.e. such that the compound comprises one or more amine functional groups and at least one alkylene oxide residue. Such compounds will be known to persons skilled in the art and may comprise further functional groups. For example, an alkoxylated amine compound may comprise one or more hydroxy functional groups in addition to the one or more amine functional groups and at least one alkylene oxide residue. Thus, the alkoxylated amine compound may be an alkoxylated alkanolamine compound.

It has been surprisingly found that the one or more biosurfactants suitably enhance the demulsifying effect compared to the use of an alkoxylated alcohol and/or amine compound alone. For example, the demulsifying effect may be enhanced by accelerating the demulsification, providing a clean interface between the aqueous and the hydrocarbon components and/or minimising residual emulsion in the aqueous component. The enhancement of the demulsifying effect may comprise the separation of at least one oil or hydrocarbon phase and at least one aqueous phase.

The additive composition may comprise any suitable alkoxylated alcohol and/or amine compound(s). Suitable alkoxylated alcohol and/or amine compound(s) may have a hydrophilic-lipophilic balance (HLB) value of from 10 to 14, for example from 11 to 13, or from 11.5 to 12.5, such as about 12. The additive composition may comprise an alkoxylated alcohol compound, or an alkoxylated amine compound, or an alkoxylated alcohol compound and an alkoxylated amine compound.

Preferably the alkoxylated alcohol and/or amine compounds include more than one alkylene oxide residue.

Suitable alkylene oxide residues include ethylene oxide residues, propylene oxide residues, butylene oxide residues and mixtures thereof. Preferably the alkoxylated alcohol and/or amine compounds include ethylene oxide residues, propylene oxide residues, or mixtures thereof.

The one or more alkoxylated alcohol and/or amine compounds may each comprise one or more alkylene oxide residues independently selected from ethylene oxide residues, propylene oxide residues and butylene oxide residues. The one or more alkoxylated alcohol and/or amine compounds may each comprise one or more alkylene oxide residues independently selected from ethylene oxide residues and propylene oxide residues.

The one or more alkoxylated alcohol compounds may be independently selected from an alkoxylated monoalcohol and an alkoxylated polyol (which may be an alkoxylated diol). By polyol we mean a compound including two or more hydroxy groups (including a diol compound).

The one or more alkoxylated amine compounds may be independently selected from an alkoxylated monoamine and an alkoxylated polyamine (which may be an alkoxylated diamine).

By polyamine we mean a compound including two or more amine groups (including a diamine compound).

Suitable alkoxylated alcohol and amine compounds for use herein may have the formula A-(RO)ₙ—H wherein A is the residue of an alcohol and/or an amine compound (such as the residue of an alcohol or an amine compound, RO is an alkylene oxide residue (i.e. wherein R represents an alkylene moiety) and n is an average value of at least one (the alkoxylated compounds comprising a distribution of alkylene oxide groups). When A is the residue of an alcohol and an amine compound, the alkoxylated alcohol and amine compound may be an alkoxylated alkanolamine compound.

R is preferably an ethylene, propylene or butylene group. R may be an n-propylene or n-butylene group or an isopropylene or isobutylene group. For example R may be —CH₂CH₂—, —CH₂CH₂CH₂—, —CH₂CH₂CH₂CH₂—, —CH₂CH(CH₃)—, —CH₂C(CH₃) 2, —CH(CH₃)CH(CH₃)— or —CH₂CH(CH₂CH₃)—. For example R may be —CH₂CH₂—, —CH₂CH(CH₃)—, —CH₂C(CH₃)₂, —CH(CH₃)CH(CH₃)— or —CH₂CH(CH₂CH₃)—. R may comprise a mixture of isomers. For example when R is propylene, the alkylene oxide residue may include the moieties —CH₂CH(CH₃)— and —CH(CH₃) CH₂— in any order within the chain.

Each R may be the same or different. R may comprise a mixture of different alkylene moieties, for example ethylene, propylene or butylene moieties.

Preferably R is ethylene and/or propylene. More preferably R is —CH₂CH₂— and/or —CH(CH₃) CH₂—, such as —CH₂CH₂— or —CH(CH₃)CH₂—. Even more preferably, R is ethylene.

n is at least 1. Preferably for an alkoxylated amine compound n is from 5 to 1000, preferably from 5 to 500, more preferably from 10 to 400, more preferably from 15 to 300, preferably from 20 to 250, suitably from 30 to 200, preferably from 50 to 150. Preferably for an alkoxylated alcohol compound n is from 1 to 15, preferably from 2 to 10, more preferably from 4 to 8.

A is the residue of an alcohol and/or amine compound, such as the residue of an alcohol or an amine compound. For example, A may be the residue of an alcohol compound having at least one hydroxy group (including the residue of a polyol). Suitable alcohol compounds may comprise from 1 to 30 carbon atoms, such as from 2 to 16 or from 8 to 16 carbon atoms. Suitable alcohol compounds may include alcohols comprising from 2 to 5 carbon atoms (such as propanediol), fatty alcohols (such as C6 to C18 fatty alcohols) and alkylphenol compounds (including alkylphenol resins). Suitable alkylphenol resins may be formed by condensing an alkylphenol compound with a suitable aldehyde compound such as formaldehyde (or a reactive equivalent thereof). For example, A may be the residue of an amine compound having at least one NH group (including the residue of a polyamine). Suitable amine compounds include primary or secondary monoamines having hydrocarbon substituents of 1 to 30 carbon atoms. For example, A may be the residue of an alkanolamine compound, such as a residue of monoethanolamine, diethanolamine, triethanolamine or isopropanolamine.

Examples of suitable alkoxylated alcohol compounds include alkoxylated alcohol compounds wherein the alcohol comprises from 2 to 5 carbon atoms, such as alkoxylated propanediol, for example ethoxylated and/or propoxylated propanediol.

Examples of suitable alkoxylated alcohol compounds include alkoxylated fatty alcohol compounds and alkoxylated alkylphenol compounds (including alkoxylated alkylphenol resins). For example, the alkoxylated alkylphenol compounds may be an alkoxylated alkylphenol or an alkoxylated alkylphenol resin.

For example, the alkoxylated alcohol compound may comprise an alkoxylated (preferably ethoxylated) fatty alcohol compound comprising an alcohol residue derived from a C6 to C24, such as a C6 to C18, fatty alcohol and an alkylene oxide residue (preferably an ethylene oxide residue), wherein the average number of alkylene oxide groups per fatty alcohol is 2 to 10. In other words, the alkoxylated alcohol compound may have the formula A-(RO) n-H wherein A is the residue of a C6 to C18 fatty alcohol, RO is an alkylene oxide (preferably ethylene oxide) residue (i.e. wherein R represents an alkylene, preferably ethylene, moiety) and n is an average value of 2 to 10.

For example, the alkoxylated alcohol compound may comprise an alkoxylated (preferably ethoxylated) fatty alcohol compound comprising an alcohol residue derived from a C8 to C12 fatty alcohol and an alkylene oxide residue (preferably an ethylene oxide residue), wherein the average number of alkylene oxide groups per fatty alcohol is 4 to 8. In other words, the alkoxylated alcohol compound may have the formula A-(RO) n-H wherein A is the residue of a C8 to C12 fatty alcohol, RO is an alkylene oxide (preferably ethylene oxide) residue (i.e. wherein R represents an alkylene, preferably ethylene, moiety) and n is an average value of 4 to 8.

An example of a suitable ethoxylated fatty alcohol compound is C9-C11 pareth-6 (which may be sold as Neodol 91-6).

An example of a suitable alkoxylated diol is OGI-9066 (available from Speciality Intermediates).

For example, the alkoxylated alcohol compound may comprise an alkoxylated (preferably ethoxylated) alkylphenol compound comprising an alcohol residue derived from a C6 to C15, such as a C6 to C12, alkylphenol and an alkylene oxide residue (preferably an ethylene oxide residue), wherein the average number of alkylene oxide groups per alkylphenol is 8 to 12. In other words, the alkoxylated alcohol compound may have the formula A-(RO) n-H wherein A is the residue of a C6 to C15, such as a C6 to C12, alkylphenol, RO is an alkylene oxide (preferably ethylene oxide) residue (i.e. wherein R represents an alkylene, preferably ethylene, moiety) and n is an average value of 8 to 12. References to a C6 to C15 alkylphenol and suchlike are intended to refer to compounds in which the alkyl group has from 6 to 15 carbon atoms.

An example of a suitable ethoxylated alkylphenol compound is ethoxylated nonylphenol (for example ethoxylated nonylphenol where the nonylphenol is ethoxylated with 9-10 moles of ethylene oxide).

A suitable alkoxylated alkylphenol resin may comprise a compound prepared by the reaction of a suitable aldehyde (such as formaldehyde) with an alkylphenol compound, for example a C6 to C24, such as a C6 to C18 or a C6 to C15, for example a C10 to C15, alkylphenol compound, to provide an alkylphenol resin and then reaction of the alkylphenol resin with an alkylene oxide (preferably ethylene oxide), wherein the average number of alkylene oxide residues per alkylphenol is 8 to 12. For example, the alkoxylated alcohol compound may have the formula A-(RO) n-H wherein A is the residue of a C6 to C15 alkylphenol resin, RO is an alkylene oxide (preferably ethylene oxide) residue (i.e. wherein R represents an alkylene, preferably ethylene, moiety) and n is an average value of 8 to 12.

Examples of suitable alkoxylated amine compounds may comprise an alkylene oxide residue and a residue of a polyamine. Suitable polyamines (from which the residue (A above) may be derived) may be selected from any compound including two or more amine groups. Preferably the polyamine is a (poly)alkylene polyamine (by which is meant an alkylene polyamine or a polyalkylene polyamine; including in each case a diamine, within the meaning of “polyamine”). Suitable, the polyamine may be a (poly)alkylene polyamine in which the alkylene component has from 1 to 6, preferably from 1 to 4, most preferably from 2 to 3, carbon atoms. Most preferably the polyamine is a (poly)ethylene polyamine (that is an ethylene polyamine or a polyethylene polyamine). Suitably, the polyamine may have from 2 to 15 nitrogen atoms, preferably from 2 to 10 nitrogen atoms, more preferably from 2 to 8 nitrogen atoms.

Suitable polyamines (from which the residue (A above) may be derived) may, for example, be selected from ethylenediamine, diethylenetriamine, triethylenetetramine, tetraethylenepentamine, pentaethylene-hexamine, hexaethyleneheptamine, heptaethyleneoctamine, propane-1,2-diamine, 2 (2-amino-ethylamino) ethanol, N′,N′-bis(2-aminoethyl) ethylenediamine (N(CH₂CH₂NH₂)₃), diphenyl-4,4′-diamine, diamino naphthalene, phenylene diamine, xylene diamine, 1,2-diaminopropane and 1,3-diaminopropane, 1,4-diaminobutane, 1,5-diamino pentane and 1,6-diamino-hexane. Preferably the polyamine (from which the residue (A above) may be derived) may be ethylenediamine.

The one or more alkoxylated amine compounds may be selected from one or more compounds of formula (I):

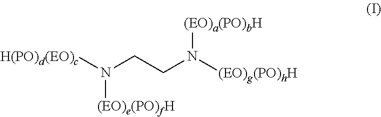

wherein EO represents an ethylene oxide residue, PO represents a propylene oxide residue and at least one of a, b, c, d, e, f, g and h is not 0.

The compounds of formula (I) may be prepared by reaction of ethylene diamine with ethylene oxide and propylene oxide (when both present) in any combination thereof and in any order, i.e. so as to provide compounds of formula (I) in which the ethylene oxide and propylene oxide residues may be present in any combination and in any order as bonded to the nitrogen of the amine group. The ethylene oxide and propylene oxide residues may be present in blocks in the compounds of formula (I).

Preferably each of a, b, c, d, e, f, g and h is at least one. Preferably the sum of a, b, c, d, e, f, g and h is from 10 to 500, suitably from 20 to 250, preferably from 40 to 200, more preferably from 50 to 150.

The skilled person will appreciate that polymeric compounds of formula (I) are usually in the form of mixtures.

Some suitable alkoxylated amine compounds for use herein are described in U.S. Pat. No. 6,838,422.

The additive composition may comprise the one or more biosurfactants in any suitable amount. For example, the additive composition may comprise at least 2 wt %, such as at least 4 wt %, of the one or more biosurfactants, and/or the additive composition may comprise up to 30 wt %, such as up to 25 wt % or up to 20 wt % of the one or more biosurfactants. The additive composition may, for example, comprise from 2 to 30 wt %, for example from 2 to 25 wt %, or from 3 to 22 wt %, of the one or more biosurfactants.

The additive composition may comprise the one or more alkoxylated alcohol and/or amine compounds in any suitable amount. For example, the additive composition may comprise at least 5 wt % of the one or more alkoxylated alcohol and/or amine compounds, and/or the additive composition may comprise up to 25 wt %, for example up to 22 wt %, such as up to 15 wt % of the one or more alkoxylated alcohol and/or amine compounds. The additive composition may, for example, comprise from 5 to 25 wt %, such as from 8 to 22 wt % of the one or more alkoxylated alcohol and/or amine compounds.

The additive composition may further comprise an additional additive selected from one or more of a solvent, a dispersant, a non-biological surfactant, a pH adjusting agent, a preservative, a stabiliser and a winterising agent. Suitable amounts of such additional additives (when present) would be known to persons skilled in the art.

Examples of suitable pH adjusting agents may include caustic soda, cyclohexylamine and phosphoric acid. Suitable amounts of pH adjusting agent(s) range from 0.5 to 2 wt %.

Examples of suitable dispersants may include acid-catalysed butyl phenol formaldehyde resin. Suitable amounts of dispersant(s) (when present) range from 3 to 20 wt %.

Examples of suitable winterising agents may include methanol and glycols, such as ethylene glycol and propylene glycol. Suitable amounts of winterising agents (when present) range from 1 to 20 wt %.

Examples of suitable stabilisers may include isopropyl alcohol and ethylene glycol monobutyl ether. Suitable amounts of stabilisers (when present) range from 1 to 20 wt %.

The additive composition may further comprise one or more solvents (including mixtures of solvents). Suitable solvents include water, alcohols (such as isopropyl alcohol), aromatic hydrocarbons (such as benzene, toluene, xylene and a C11-C14 aromatic hydrocarbon) and ethers (such as ethylene glycol monobutyl ether and 2-butoxyethanol) (and mixtures thereof). As would be understood by the skilled person, some solvents may also function as stabilisers. Suitable amounts of solvent(s) (when present) range from 45 to 95 wt %, such as from 45 to 85 wt % or from 50 to 85 wt %.

Preferably the additive composition comprises water, for example in an amount of from 45 to 95 wt %, such as from 45 to 85 wt % or from 50 to 85 wt %.

The additive composition may further comprise one or more non-biological surfactants.

Suitable non-biological surfactants include non-biological anionic surfactants such as sulfated or sulfonated non-biological surfactants. Examples of such non-biological surfactants include alkyl sulfates (for example sodium dodecyl sulfate), alkyl ether sulfates (for example sodium lauryl ether sulfate, ammonium lauryl ether sulfate), alkyl benzene sulfonic acids (for example dodecyl benzene sulfonic acid (DDBSA), diisopropylmethylene sulfonic acid), dialkylbenzene sulfonic acids (for example dinonylnaphthylsulfonic acid), alkyl benzene sulfonates, dialkylbenzene sulfonates, alkyl naphthalene sulfonates, sulfosuccinate esters (for example di(2-ethylhexyl) sulfosuccinate and olefin sulfonates (for example sodium C14-16 olefin sulfonate). Suitable amounts of non-biological surfactants (when present) range from 1 to 30 wt %, such as from 2 to 25 wt %, preferably from 5 to 22 wt %.

The additive composition may further comprise one or more additional conventional demulsifier compounds in addition to the biosurfactant and to any alkoxylated alcohol and/or amine compounds when present. Thus, the additional conventional demulsifier compounds(s) (when present) are not biosurfactants or alkoxylated alcohol and/or amine compounds. Suitable additional conventional demulsifier compounds include resins, polyol esters, sulfonate, polyglycols, polymerised polyols and diepoxide compounds Suitable amounts of additional conventional demulsifier compounds (when present) range from 0.5 to 20 wt %.

The method of the first aspect and the use of the second aspect of the invention may use one or more additional additives to demulsify a hydrocarbon emulsion in addition to the one or more biosurfactants.

Thus, the first aspect of the invention may provide a method of demulsifying a hydrocarbon emulsion, wherein the method comprises adding one or more biosurfactants and one or more additional additives to the hydrocarbon emulsion.

Thus, the second aspect of the invention may provide the use of one or more biosurfactants and one or more additional additives to demulsify a hydrocarbon emulsion.

For example, the method and use of the invention may make use of one or more biosurfactants and one or more additional additives. In this case, the one or more biosurfactants and one or more additional additives may be added to the hydrocarbon emulsion, or used, together, for example as components of an additive composition (such as an additive composition as disclosed herein), and/or separately. When the one or more biosurfactants and the one or more additional additives are added to the hydrocarbon emulsion, or used, separately, the one or more biosurfactants and the one or more additional additives may be added, or used, concurrently or sequentially in any suitable order.

According to the method and use of the invention, the one or more biosurfactants and one or more additional additives may be added to the hydrocarbon emulsion, or used, together, for example as components of an additive composition (such as an additive composition as disclosed herein), and one or more of the biosurfactants or additional additives may additionally be added to the hydrocarbon emulsion, or used, separately. For example the method and use of the invention may comprise the addition of one or more biosurfactants and one or more additional additives to the hydrocarbon emulsion together as components of an additive composition (such as an additive composition as disclosed herein), and additionally the separate addition of one or more of the additional additives (which may be the same or different to the additional additives comprised in the additive composition).

The one or more additional additives discussed in relation to the method and use of the first and second aspects of the invention may comprise any suitable additional additives. For example, the one or more additional additives may comprise one or more alkoxylated alcohol and/or amine compounds as discussed herein in relation to the additive composition. For example, the one or more additional additives may additionally or alternatively comprise an additional additive selected from one or more of a solvent, a dispersant, a non-biological surfactant, a pH adjusting agent, a preservative, a stabiliser and a winterising agent as discussed herein in relation to the additive composition.

The one or more biosurfactants may be added to the hydrocarbon emulsion in any suitable manner. For example, the biosurfactants may be added to the hydrocarbon emulsion as a component of an additive composition (such as an additive composition of the third aspect of the invention). The one or more biosurfactants (or the additive composition) may be mixed and/or dispersed within the hydrocarbon emulsion. For example, the one or more biosurfactants (or the additive composition) may be added to a stirred hydrocarbon emulsion which is heated to a suitable temperature (according to the particular hydrocarbon emulsion), following by cooling without heating. Alternatively, the one or more biosurfactants (or the additive composition) may be added to a hydrocarbon emulsion, for example an oil in water emulsion, without further heating.

The hydrocarbon emulsion may be at 65° C. (149° F.) or below, for example 55° C. (131° F.) or below when contacted with the one or more biosurfactants (or the additive composition). The hydrocarbon emulsion may be above ambient temperature when contacted with the one or more biosurfactants (or the additive composition), for example above 30° C. (86° F.), such as above 35° C. (95° F.).

The hydrocarbon emulsion is suitably not heated after contact with the one or more biosurfactants (or the additive composition). In this way, the present invention may reduce environmental impact and complexity involved in demulsification of hydrocarbon emulsions.

Suitably, the one or more biosurfactants (or the additive composition) may be added to a container and the hydrocarbon emulsion (for example an oil in water emulsion) loaded into the container such that the one or more biosurfactants (or the additive composition) and the hydrocarbon emulsion are mixed.

The method and use of the present invention may be carried out in transit, for example in a container being transported (such as in a tanker trailer). Such a container may be unheated.

The method or use of the invention may be used with any hydrocarbon emulsion from which it is desired to separate an aqueous component (e.g. water or brine) from the hydrocarbon component of the emulsion.

The hydrocarbon component of the emulsion may be a crude or refined hydrocarbon. A refined hydrocarbon may typically be substantially free or free of metals, sulfur and naphthenic acid-based species. A refined hydrocarbon may additionally be substantially free or free of asphaltenes.

By “substantially free” of for example metals, sulfur, asphaltenes and naphthenic acid-based species we mean that any metals, sulfur, asphaltenes and naphthenic acid-based species that are present, if any, are present as an incidental impurity. By “free” of for example metals, sulfur, asphaltenes and naphthenic acid-based species we mean that no metals, sulfur, asphaltenes and naphthenic acid-based species are present.

For example, by substantially free of sulfur, we mean less than 200 ppm by weight of sulfur is present. For example, by substantially free of metals, we mean less than 500 ppm by weight of metals is present.

Suitable hydrocarbon emulsions include those in which the hydrocarbon component is a waste and/or processed hydrocarbon. Typically, the hydrocarbon component is a waste hydrocarbon For example, the hydrocarbon component of the hydrocarbon emulsion may be a waste hydrocarbon from the shipping industry. A preferred hydrocarbon emulsion may be slop oil, for example from a ship or refinery, suitably the slop oil may be an oil in water emulsion.

Suitable hydrocarbon emulsions include oil in water emulsions, such as a waste oil in water emulsion.

Suitable hydrocarbon emulsions include those in which the hydrocarbon is selected from one or more of a residual fuel oil (such as high sulfur fuel oil, very low sulfur fuel oil and ultra low sulfur fuel oil), a distillate fuel oil, a bio-derived fuel oil, a cracked process stream, a synthetic fuel, a gas oil (such as vacuum gas oil, light heating oil, diesel and middle distillate), a lubricating oil and a plastic pyrolysis oil. For example, in particular, the hydrocarbon may be selected from one or more of crude oil, heavy fuel oil, gasoline, kerosenes, diesel fuels, transformer oils, turbine oils, heating oils, marine fuels, bunker oils and lubricating oils. More particularly, the hydrocarbon may be selected from one or more of heavy fuel oil, gasoline, kerosenes, diesel fuels, transformer oils, turbine oils, heating oils, marine fuels, bunker oils and lubricating oils. The hydrocarbon may be crude oil. The hydrocarbon may comprise a blend of different types and/or feedstocks of hydrocarbons.

Typically, the hydrocarbon emulsion has formed by addition of an aqueous component (e.g. water or brine) to the hydrocarbon component so as to form an emulsion, such as during the processing of the hydrocarbon. In some cases, the hydrocarbon emulsion has formed as a result of cleaning of hydrocarbon processing, storage or transport infrastructure.

The hydrocarbon emulsion may comprise a hydrocarbon component and an aqueous component.

For example, the aqueous component may be present in the hydrocarbon emulsion in an amount of greater than 5 vol %, for example greater than 10 vol %, or greater than 25 vol %, greater than 35 vol %, greater than 45 vol %, suitably greater than 55 vol %. For example, the aqueous component may be present in an amount of less than 80 vol % or less than 75 vol %. For example, the aqueous component may be present in an amount of 5 to 75 vol %, such as from 25 to 75 vol % or from 55 to 75 vol %.

For example, the hydrocarbon component may be present in the hydrocarbon emulsion in an amount of greater than 5 vol %, for example greater than 10 vol %, or greater than 25 vol %. For example, the hydrocarbon component may be present in an amount of less than 70 vol %, for example less than 60 vol % or less than 55 vol %. For example, the hydrocarbon component may be present in an amount of 25 to 70 vol %, such as from 25 to 60 vol % or from 25 to 55 vol %.

The aqueous component of the hydrocarbon emulsion may be selected from one or more of fresh water, waste-water, brine and brackish water. The aqueous component may have been added to the hydrocarbon component for processing purposes.

The hydrocarbon emulsion may arise from accumulation of hydrocarbon and aqueous waste in shipping or refinery industries, such as slop oil. Such emulsions present environmental concerns and would otherwise be disposed of. Demusification of such emulsions may reduce waste, reduce environmental impact and/or allow components to be re-purposed in other applications for example as asphalt or roofing material.

The one or more biosurfactants may be added to the hydrocarbon emulsion in any suitable amount. For example, the one or more biosurfactants may be added to the hydrocarbon emulsion at a concentration of from 0.1 ppm to 1000 ppm, for example of from 100 to 900 ppm, preferably from 160 to 800 ppm.

For example, the one or more alkoxylated alcohol and/or amine compounds (when present) may be added to the hydrocarbon emulsion at a concentration of from 50 to 2000 ppm, for example from 100 to 1500 ppm, preferably from 400 to 800 ppm.

The additive composition may be added to the hydrocarbon emulsion at a concentration of from 100 to 9000 ppm, for example from 250 to 9000 ppm, preferably from 500 to 7500 ppm.

The additive composition may be added to the hydrocarbon emulsion in an amount wherein the concentration of the one or more biosurfactants is from 100 to 900 ppm, preferably from 150 to 800 ppm or from 160 to 800 ppm.

The additive composition may be added to the hydrocarbon emulsion in an amount wherein the concentration of the one or more alkoxylated alcohol and/or amine compounds is from 50 to 2000 ppm, for example from 100 to 1500 ppm, preferably from 400 to 800 ppm.

The additive composition may be added to the hydrocarbon emulsion in an amount wherein the concentration of the one or more biosurfactants is from 100 to 900 ppm, preferably from 160 to 800 ppm and in an amount wherein the concentration of the one or more alkoxylated alcohol and/or amine compounds is from 50 to 2000 ppm, for example from 100 to 1500 ppm, preferably from 400 to 800 ppm.

The additive composition may comprise one or more alkoxylated alcohol compounds and may be added to the hydrocarbon emulsion in an amount wherein the concentration of the one or more biosurfactants is from 100 to 900 ppm, preferably from 160 to 800 ppm, and in an amount wherein the concentration of the one or more alkoxylated alcohol compounds is from 50 to 2000 ppm, for example from 100 to 1500 ppm, preferably from 400 to 800 ppm.

The additive composition may comprise one or more alkoxylated amine compounds and may be added to the hydrocarbon emulsion in an amount wherein the concentration of the one or more biosurfactants is from 100 to 900 ppm, preferably from 160 to 800 ppm, and in an amount wherein the concentration of the one or more alkoxylated amine compounds is from 50 to 2000 ppm, for example from 100 to 1500 ppm, preferably from 400 to 800 ppm.

The additive composition may comprise one or more alkoxylated alcohol and one or more alkoxylated amine compounds and may be added to the hydrocarbon emulsion in an amount wherein the concentration of the one or more biosurfactants is from 100 to 900 ppm, preferably from 160 to 800 ppm, and in an amount wherein the concentration of the total of the one or more alkoxylated alcohol compounds and one or more alkoxylated amine compounds is from 50 to 2000 ppm, for example from 100 to 1500 ppm, preferably from 400 to 800 ppm.

According to a third aspect of the invention, there is provided an additive composition comprising one or more biosurfactants and one or more alkoxylated alcohol and/or amine compounds.

Features of the additive composition of the third aspect of the invention, for example including of the biosurfactants, the alkoxylated alcohol and amine compounds and the additional components comprised therein, are as set out herein in relation to the method and use of the first and second aspects.

In particular, in the additive composition of the third aspect of the invention, the one or more biosurfactants may be independently selected from a glycolipid, a lipopeptide, a phospholipid and a polymeric biosurfactant (and mixtures thereof). The one or more biosurfactants may be glycolipids, especially sophorolipids.

The additive composition of the third aspect of the invention may comprise the one or more biosurfactants in any suitable amount. For example, the additive composition may comprise at least 2 wt %, such as at least 4 wt %, of the one or more biosurfactants, and/or the additive composition may comprise up to 30 wt %, such as up to 25 wt % or up to 20 wt % of the one or more biosurfactants. The additive composition may, for example, comprise from 2 to 30 wt %, for example from 2 to 25 wt %, or from 3 to 22 wt %, of the one or more biosurfactants.

The additive composition of the third aspect of the invention may comprise the one or more alkoxylated alcohol and/or amine compounds in any suitable amount. For example, the additive composition may comprise at least 5 wt % of the one or more alkoxylated alcohol and/or amine compounds, and/or the additive composition may comprise up to 25 wt %, for example up to 22 wt %, such as up to 15 wt % of the one or more alkoxylated alcohol and/or amine compounds. The additive composition may, for example, comprise from 5 to 25 wt %, such as from 8 to 22 wt %, of the one or more alkoxylated alcohol and/or amine compounds.

The additive composition of the third aspect of the invention may further comprise an additional additive selected from one or more of a solvent, a dispersant, a non-biological surfactant, a pH adjusting agent, a preservative, a stabiliser and a winterising agent.

The additive composition of the third aspect of the invention may further comprise one or more solvents (including mixtures of solvents). Suitable solvents include water, alcohols (such as isopropyl alcohol), aromatic hydrocarbons (such as benzene, toluene, xylene and a C₁₁-C₁₄ aromatic hydrocarbon) and ethers (such as ethylene glycol monobutyl ether and 2-butoxyethanol) (and mixtures thereof). Suitable amounts of solvent(s) (when present) range from 45 to 95 wt %, such as from 45 to 85 wt % or from 60 to 85 wt %.

Preferably the additive composition of the third aspect of the invention comprises water, for example in an amount of from 45 to 95 wt %, such as from 45 to 85 wt % or from 50 to 85 wt %.

An additive composition comprising water as a solvent may be termed a water-based additive composition. By a water-based composition we mean that the majority of the solvent in the composition is water, for example at least 50 wt %, preferably at least 60 wt %, of the solvent present is water.

The third aspect of the invention may provide a water-based additive composition comprising one or more biosurfactants, one or more alkoxylated alcohol and/or amine compounds and water.

The additive composition of the third aspect of the invention may further comprise one or more non-biological surfactants.

Suitable non-biological surfactants include non-biological anionic surfactants such as sulfated or sulfonated non-biological surfactants. Examples of such non-biological surfactants include alkyl sulfates (for example sodium dodecyl sulfate), alkyl ether sulfates (for example sodium lauryl ether sulfate, ammonium lauryl ether sulfate), alkyl benzene sulfonic acids (for example dodecyl benzene sulfonic acid (DDBSA), diisopropylmethylene sulfonic acid), dialkylbenzene sulfonic acids (for example dinonylnaphthylsulfonic acid), alkyl benzene sulfonates, dialkylbenzene sulfonates, alkyl naphthalene sulfonates, sulfosuccinate esters (for example di(2-ethylhexyl) sulfosuccinate and olefin sulfonates (for example sodium C14-16 olefin sulfonate). Suitable amounts of non-biological surfactants (when present) range from 1 to 30 wt %, such as from 2 to 25 wt %, preferably from 5 to 22 wt %.

The additive composition of the third aspect of the invention may further comprise one or more additional demulsifier compounds in addition to the biosurfactant. Thus, the additional demulsifier compounds(s) (when present) are not biosurfactants. Suitable additional demulsifiers include resins, polyol esters, sulfonate, polyglycols, polymerised polyols and diepoxide compounds. Suitable amounts of additional demulsifier compounds (when present) range from 0.5 to 20 wt %.

The additive composition of the third aspect of the invention may be stable over three freeze thaw cycles alternating between 21° C. and −30° C.

The invention may further provide a method of demulsifying a hydrocarbon emulsion, the method comprising adding an additive composition according to the third aspect of the invention to the hydrocarbon emulsion.

The invention may further provide the use of an additive composition according to the third aspect of the invention to demulsify a hydrocarbon emulsion.

According to a fourth aspect of the invention, there is provided a method of demulsifying a hydrocarbon emulsion, the method comprising adding a water-based additive composition to the hydrocarbon emulsion, wherein the water-based additive composition comprises one or more biosurfactants.

According to a fifth aspect of the invention, there is provided the use of a water-based additive composition to demulsify a hydrocarbon emulsion, wherein the water-based additive composition comprises one or more biosurfactants.

In the fourth and fifth aspects of the invention, the hydrocarbon emulsion may comprise a waste hydrocarbon, such as a waste lubricating oil.

Features of the method and use of the fourth and fifth aspects of the invention, and of the additive composition for use therein, are as set out herein in relation to the first, second and third aspects.

According to a sixth aspect of the invention, there is provided an additive kit comprising a first additive composition comprising one or more biosurfactants and one or more alkoxylated alcohol and/or amine compounds and a second additive composition.

In the sixth aspect of the invention, the first additive composition may comprise an additive composition according to the third aspect of the invention as disclosed herein. The second additive composition may comprise one or more of (i), (ii) and (iii) as follows:
(i) one or more biosurfactants
(ii) one or more alkoxylated alcohol and/or amine compounds
(iii) one or more of a solvent, a dispersant, a non-biological surfactant, a pH adjusting agent, a preservative, a stabiliser and a winterising agent.

Features of the additive kit according to the sixth aspect of the invention are as set out herein in relation to the first, second and third aspects.

For example, the additive kit may comprise a first additive composition comprising an additive composition according to the third aspect of the invention as disclosed herein and a second additive composition comprising one or more alkoxylated alcohol and/or amine compounds.

The invention may further provide a method of demulsifying a hydrocarbon emulsion, the method comprising adding an additive kit according to the sixth aspect of the invention to the hydrocarbon emulsion.

The invention may further provide the use of an additive kit according to the sixth aspect of the invention to demulsify a hydrocarbon emulsion.

### BRIEF DESCRIPTION OF THE FIGURES

FIG. 1 shows a slop oil sample prior to demulsification as described in relation to Example 2. The slop oil appears as a viscous, black liquid.

FIG. 2 shows a slop oil sample following demulsification as described in relation to Example 2. Resolved hydrocarbon, aqueous and sediment layers are clearly visible.

The invention will now be further described with reference to the following non-limiting examples.

### EXAMPLE 1

An additive composition 1 was prepared by mixing together the components as shown in Table 1:

TABLE 1

| Component | % by weight |
|---|---|
| Water | 66 |
| Sophorolipid | 20 |
| C9-C11 pareth-6 | 10 |
| EGMBE | 4 |

EGMBE = ethylene glycol monobutyl ether
C9-C11 pareth-6 = commercially available mixture of C9 and C11 alcohols, ethoxylated with an average of 6 mole equivalents of ethylene oxide
Sophorolipid = commercially available sophorolipid with an acid/lactone ratio of 60:40

Demulsification tests 1 to 4 were conducted as follows:

A graduated, prescription bottle was filled with 100 ml of a waste oil emulsion and then heated to about 65° C. Whilst maintaining a temperature of about 65° C., an additive composition was then added at the specified treat rate. The bottle was then sealed and shaken 100 times by hand. The bottle was then left to stand for 24 hours at room temperature and the amount of water that separated out was measured and recorded.

### Test 1

The waste oil emulsion tested was a sample of a commercially provided waste oil emulsion comprising 40 vol % oil and 60 vol % water. and the results are shown in Table 2.

TABLE 2

| | Treat Rate | |
|---|---|---|
| Additive composition | (ppm) | 24 hour result |
| Blank | 0 | No Resolution |
| DMO-3070 | 500 | 5 ml water |
| DMO-3070 | 4,000 | 20 ml water |
| C9-C11 pareth-6 | 1,000 | 3 ml water |
| Additive composition 1 | 4,000 | 52 ml water |
| Additive composition 1* | 4,000 | 59 ml water |
| C9-C11 pareth-6* | 1,000 | |

DMO-3070 = commercially available demulsifier package (without biosurfactant)
*4,000 ppm of Additive composition 1 added, followed immediately by addition of 1,000 ppm of C9-C11 pareth-6

### Test 2

The waste oil emulsion tested was a sample of a commercially provided waste oil emulsion comprising 50 vol % oil and 50 vol % water and the results are shown in Table 3.

TABLE 3

| | Treat Rate | |
|---|---|---|
| Additive composition | (ppm) | 24 hour result |
| Blank | 0 | No Resolution |
| Additive composition 1* | 4,000 | 40 ml water |
| C9-C11 pareth-6 | 1,000 | |

*4,000 ppm of Additive composition 1 added, followed immediately by addition of 1,000 ppm of C9-C11 pareth-6

### Test 3

The waste oil emulsion tested was a sample of a commercially provided waste oil emulsion comprising 30 vol % oil and 70 vol % water and the results are shown in Table 4.

TABLE 4

| Product | Treat Rate ppm | 24 hr Result |
|---|---|---|
| Blank | 0 | No Resolution |
| Additive composition 1* | 4,000 | 69 ml water |
| C9-C11 pareth-6 | 1,000 | |

*4,000 ppm of Additive composition 1 added, followed immediately by addition of 1,000 ppm of C9-C11 pareth-6

### EXAMPLE 2

An additive composition 2 was provided as shown in Table 5:

TABLE 5

| Component | % by weight |
|---|---|
| Water | 73 |
| Sophorolipid | 4 |
| N 9.5 | 12 |
| DDBSA | 5 |
| Isopropyl alcohol | 3 |
| Butyl cellosolve | 3 |

N 9.5 = nonyl phenol ethoxylated with 9.5 moles of ethylene oxide
DDBSA = dodecyl benzene sulfonic acid
Sophorolipid = sophorolipid with an acid/lactone ratio of 60:40 commercially available

### Test 4

Demulsification tests were conducted as set out in Example 1. The waste oil emulsion tested was a sample of a commercially provided waste oil emulsion comprising 60 vol % oil and 40 vol % water and the results are shown in Table 6.

TABLE 6

| Product | Treat Rate ppm | 24 hr Result |
|---|---|---|
| Additive composition 2 | 4,000 | 38 ml water |
| DDBSA* | 2,000 | 25 ml water |
| C9-C11 pareth-6* | 2,000 | |

*2,000 ppm of DDBSA added, followed immediately by addition of 2,000 ppm of C9-C11 pareth-6

### Test 5

Large scale demulsification tests were conducted as follows:

An empty tanker trailer was loaded with 25 gallons of additive composition 2 followed by 6,000 gallons of a slop oil (a treat rate of 4000 ppm). The components were mixed by the loading process. The temperature of the slop oil was approximately 38 to 54° C. (100 to 130° F.) on contact. No further heating was applied. The tanker trailer was moved by road to a new location (journey time about 5.5 hours) and unloaded approximately 13 hours after loading.

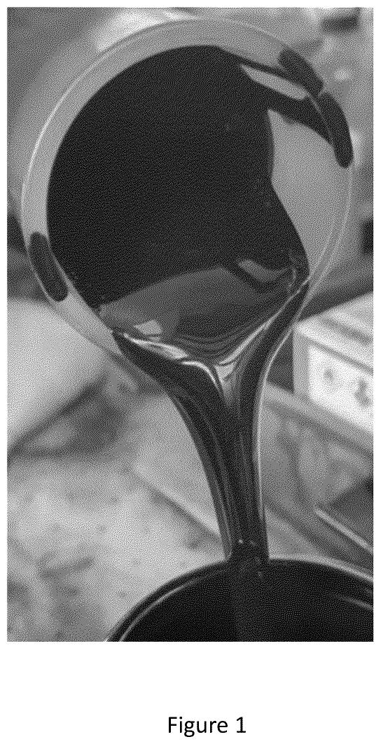

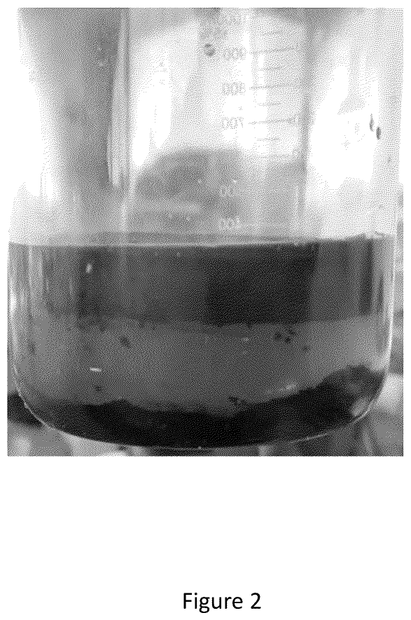

The slop oil prior to treatment was a viscous, black oil in water emulsion, as shown in FIG. 1. The resulting demulsified mixture is shown in FIG. 2. The demulsified oil component was recovered and had a water in oil phase content of <1%.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A method of demulsifying a hydrocarbon emulsion, the method comprising adding one or more biosurfactants to the hydrocarbon emulsion.

2. The use of one or more biosurfactants to demulsify a hydrocarbon emulsion.

3. The method of claim 1, wherein the one or more biosurfactants are independently selected from a glycolipid, a lipopeptide, a phospholipid and a polymeric biosurfactant.

4. The method of claim 3, wherein the one or more biosurfactants are glycolipids.

5. The method of claim 4, wherein the one or more biosurfactants are independently selected from a rhamnolipid, a trehalolipid, a sophorolipid and a mannosylerythritol lipid.

6. The method of claim 3, wherein the one or more biosurfactants are lipopeptides.

7. The method of claim 3, wherein the one or more biosurfactants are phospholipids.

8. The method of claim 3, wherein the one or more biosurfactants are polymeric biosurfactants.

9. The method of claim 1, wherein the one or more biosurfactants are comprised in an additive composition, wherein the additive composition further comprises one or more alkoxylated alcohol and/or amine compounds.

10. The method of claim 9, wherein the additive composition further comprises one or more of a solvent, a dispersant, a non-biological surfactant, a pH adjusting agent, a preservative, a stabiliser and a winterising agent.

11. The method of claim 9, wherein the additive composition comprises from 2 to 30 wt % of the one or more biosurfactants.

12. The method of claim 1, wherein the one or more biosurfactants are added to the hydrocarbon emulsion at a concentration of from 0.1 ppm to 1000 ppm.

13. The method of claim 9, wherein the additive composition is added to the hydrocarbon emulsion at a concentration of from 100 to 9000 ppm.

14. The method of claim 1, wherein the hydrocarbon emulsion comprises a hydrocarbon component which is a waste and/or processed hydrocarbon.

15. The method of claim 1, wherein the hydrocarbon emulsion comprises a hydrocarbon component which is selected from a residual fuel oil, a distillate fuel oil, a bio-derived fuel oil, a cracked process stream, a synthetic fuel, a gas oil, a lubricating oil and a plastic pyrolysis oil.

16. The method of claim 1, wherein the hydrocarbon emulsion comprises a hydrocarbon component which is crude oil.

17. The method of claim 1, wherein the hydrocarbon emulsion comprises an aqueous component which is selected from one or more of waste-water, brine, freshwater and brackish water.

18. The method of claim 1, wherein the hydrocarbon emulsion is an oil in water emulsions, for example a waste oil in water emulsion.

19. An additive composition comprising one or more biosurfactants and one or more alkoxylated alcohol and/or amine compounds.

20. The additive composition according to claim 19, wherein the one or more biosurfactants are independently selected from a glycolipid, a lipopeptide, a phospholipid and a polymeric biosurfactant.

21. The additive composition according to claim 20, wherein the one or more biosurfactants are glycolipids, for example wherein the one or more biosurfactants are independently selected from a rhamnolipid, a trehalolipid, a sophorolipid and a mannosylerythritol lipid.

22. The additive composition according to claim 20, wherein the one or more biosurfactants are lipopeptides.

23. The additive composition according to claim 20, wherein the one or more biosurfactants are phospholipids.

24. The additive composition according to claim 20, wherein the one or more biosurfactants are polymeric biosurfactants.
